(19) United States
(12) Patent Application Publication
(10) Pub. No.: US 2005/0230901 A1
(43) Pub. Date: Oct. 20, 2005

(54) Apparatus for separating printing plates

(75) Inventor: Bernd Lassen, Monkeberg (DE)

Correspondence Address: LERNER AND GREENBERG, PA, P O BOX 2480, HOLLYWOOD, FL, 33022-2480, US

(73) Assignee: Heidelberger Druckmaschinen AG

(21) Appl. No.: 11/080,711

(22) Filed: Mar. 15, 2005

(30) Foreign Application Priority Data
Mar. 29, 2004 (DE) 10 2004 015 195.4

(51) Int. Cl. B41F 1/00; B65H 3/46; B41L 47/14

(52) U.S. Cl. 271/106

(57) ABSTRACT

An apparatus for separating printing plates that are preferably separated from one another in a stack by intermediate layers disposed between the printing plates. The apparatus has a lifting device for lifting a printing plate from the stack. The lifting device has at least one suction element, and is a component part of a loading device of a unit for setting images on printing plates. The apparatus is configured as compactly as possible, preferably also for easier retrofitting. Accordingly, the object is achieved in that at least two suction elements which are independent of one another are provided, of which at least one suction element can be pivoted or angled away relative to the at least one other suction element.

### BACKGROUND OF THE INVENTION

Field of the Invention

The invention relates to an apparatus for separating printing plates which are preferably separated from one another in a stack individually by intermediate layers. The apparatus has a lifting device for lifting a printing plate from the stack, which lifting device contains at least one suction element, in particular as a component part of a loading device of a unit for setting images on printing plates.

An apparatus of the stated generic type is known from published, non-prosecuted German patent application No. DE 101 34 151 A1 (corresponding to U.S. Pat. No. 6,779,793 B2).

The known apparatus has an additional separating device for separating an object that might be adhering to the underside of a lifted printing plate and could be an intermediate layer or a further printing plate.

### SUMMARY OF THE INVENTION

It is accordingly an object of the invention to provide an apparatus for separating printing plates which overcomes the above-mentioned disadvantages of the prior art devices of this general type, which is formed as compactly as possible, and configured for easier retrofitting.

With the foregoing and other objects in view there is provided, in accordance with the invention, an apparatus for separating printing plates from a stack, the printing plates are disposed in the stack separated from one another individually by intermediate layers disposed between the printing plates. The apparatus contains a lifting device for lifting a printing plate from the stack. The lifting device is a component part of a loading device of a unit for setting images on the printing plates. The lifting device has at least two suction elements that are independent of one another. At least a first of the suction elements is pivoted or angled away relative to a second of the suction elements.

According to the invention, the object is achieved in that at least two suction elements which are independent of one another are provided, of which at least one suction element can be pivoted or angled away relative to the at least one other suction element.

If the suction elements are at an angle with respect to one another after a printing plate has been attracted by suction and lifted, the printing plate that is attracted by suction is advantageously (somewhat) bent as a result. An object that is adhering to the printing plate drops off as a result of this bending. This therefore dispenses with the need for an additional separating device which, however, could nevertheless be provided as a precaution.

According to one development of the invention, particularly good contact with the printing plate which is attracted by suction, and the handling of the latter, are ensured by the fact that the independent suction elements are component parts of at least two separate suction heads which provide suction faces for a printing plate which is to be attracted by suction and of which at least one suction head is mounted as a pivoting head, in such a way that its suction face can be moved, preferably tilted, at an angle to the suction face of the at least one other suction head.

Another development of the invention provides for the independent suction elements and/or the separate suction heads to have vacuum devices that can be switched independently. As a result, after having been bent the printing plate can advantageously be given over to one of the two independent suction elements or one of the separate suction heads alone by switching off the other suction element. Consequently, the printing plate is preferably given over to the suction element which is angled away, as a result of which the printing plate is flattened again and overall assumes the angle of inclination which is defined by the suction element, which facilitates and favors feeding the printing plate into an image-setting device, preferably via a slide. For this purpose, according to one development of the invention, it is preferably additionally provided that at least one part of the separating apparatus which at least contains the pivotable suction element can be moved in a substantially horizontal direction while carrying with it a printing plate which is attracted by suction.

Consequently, the separation apparatus according to the invention can preferably be positioned on a unit for setting images on printing plates, as a component part of a loading apparatus, as a result of which this unit can be retrofitted or fitted in a simple and inexpensive way.

Other features which are considered as characteristic for the invention are set forth in the appended claims.

Although the invention is illustrated and described herein as embodied in an apparatus for separating printing plates, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, vertical sectional view through a separation apparatus according to the invention above an entry slide of a unit for setting images on printing plates;

FIG. 2 is an enlarged illustration of a subregion of the section according to FIG. 1;

FIG. 3 is a diagrammatic, side view of an external drum exposer with a loading device which is positioned on top of it and contains the separation apparatus according to FIG. 1; and

FIG. 4 is a diagrammatic, side view of a flat bed exposer with a loading device.

### DESCRIPTION OF THE PREFERRED EMBODIMENTS

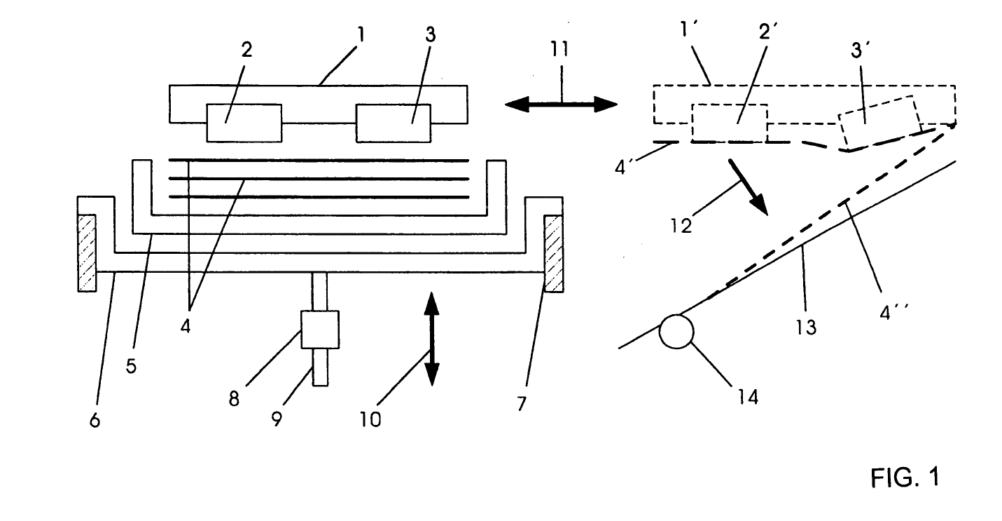

Referring now to the figures of the drawing in detail and first, particularly, to FIG. 1 thereof, there is shown a diagrammatic, vertical sectional view through a separation apparatus according to the invention above an entry slide of a unit for setting images on printing plates.

The separation apparatus contains a suction unit 1 with suction heads 2, 3 above a stack of printing plates 4, the stack being laid onto a tray 5 which is in turn pushed into a type of shell 6. The tray 5 can also be a cassette that is open on its top side.

The shell 6 is mounted on springs 7 and can be moved up and down along a guide 9 in the direction of a double arrow 10 by using an actuator 8, in order to keep the printing plate level constant as the stack height changes.

The suction unit 1 can be moved in the horizontal direction in the direction of a double arrow 11 while carrying with it a printing plate 4′ which is attracted by suction, to be precise until it is above an entry slide 13 of a unit (not shown in greater detail) for setting images on printing plates.

The moved suction unit 1′ with its suction heads 2′, 3′ is illustrated with dashed lines, as is the printing plate 4′ which is attracted by suction.

As shown, the suction head 3′ can be angled away or tilted with respect to the suction head 2′, with the result that the printing plate 4′ is slightly bent or tilted by the two suction heads 2′, 3′ in an intermediate region. As the printing plate 4′ is no longer flat as a result, an object that might be adhering to the underside drops off. Moreover, this can also occur at another location and does not have to happen exclusively above the entry slide 13. For example, the suction unit 1 in the illustration of FIG. 1 could be moved initially to the left to the side facing away from the entry slide 13, in order, for example, to throw off a separating layer there which is adhering to the printing plate 4′, and could then be moved into the position above the entry slide 13. There, the printing plate 4′ is also prestressed in the direction of an arrow 12 toward the entry slide, by the tilting of the suction head 3′. If the suction head 2′ is then switched off and the printing plate 4′ is held only by the suction head 3′, that edge of the printing plate 4′ which is then free initially falls in the direction of the arrow 12 onto the entry slide 13. If the suction head 3′ is also switched off after this, the printing plate falls completely onto the entry slide 13, the printing plate being situated transitionally for instance in the position 4″ before it rests flat on the entry slide 13.

With the assistance of transport rollers 14, the printing plate 4″ is then conveyed on the entry slide 13 into the unit for setting images on printing plates.

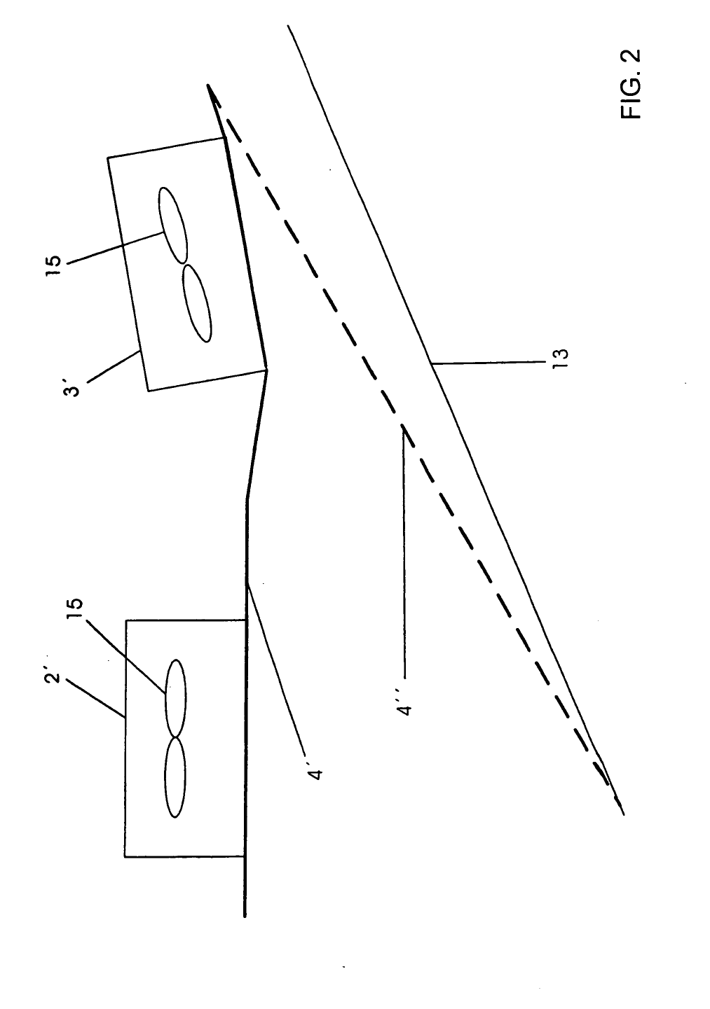

FIG. 2 shows the suction heads 2′, 3′ according to FIG. 1 once again, in a somewhat enlarged illustration. Vacuum devices 15 are now also indicated in the respective suction heads 2′, 3′, which vacuum devices 15 can be switched independently of one another. As also in the other figures identical components are designated by the same reference numerals as in FIG. 1.

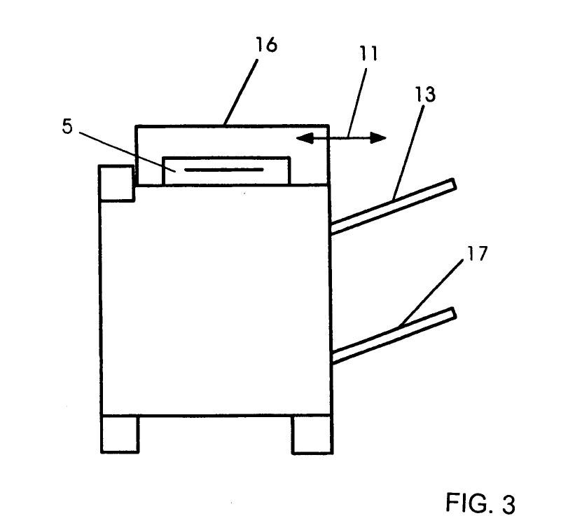

FIG. 3 shows a side view of an external drum exposer for printing plates on top of which a loading device 16 is positioned. A cassette 5 with printing plates is pushed into the loading device 16. The loading device contains the suction unit 1 which cannot, however, be seen in FIG. 3 and which can be moved over the entry slide 13 along the double arrow 11. The printing plates can be removed from a printing plate delivery device 17 after image setting.

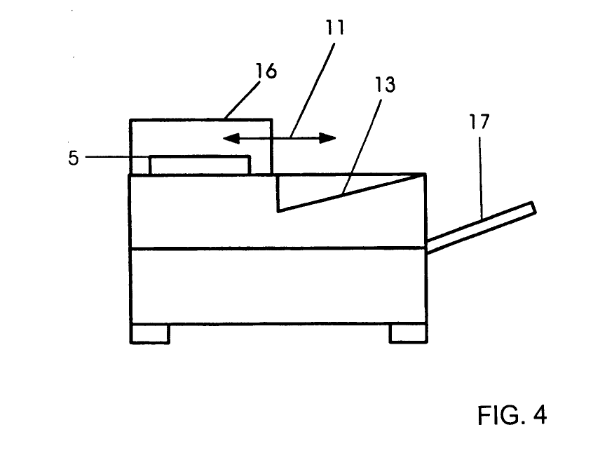

FIG. 4 shows a flat bed exposer for printing plates in a side view which corresponds to the side view of the external drum exposer from FIG. 3 and which contains the same designations. The flat bed exposer is of somewhat more compact construction, as its flat bed (which cannot be seen) requires less installation space than the image-setting drum of the external drum exposer. As a result, it is possible in particular, for the entry slide 13 to be further integrated into the housing of the exposer as part of a recess.

This application claims the priority, under 35 U.S.C. § 119, of German patent application No. 10 2004 015 195.4-27, filed Mar. 29, 2004; the entire disclosure of the prior application is herewith incorporated by reference.

1. An apparatus for separating printing plates from a stack, the printing plates disposed in the stack separated from one another individually by intermediate layers disposed between the printing plates, the apparatus comprising:
a lifting device for lifting a printing plate from the stack, said lifting device being a component part of a loading device of a unit for setting images on the printing plates, said lifting device having at least two suction elements being independent of one another, at least a first of said suction elements being pivoted or angled away relative to a second of said suction elements.

2. The apparatus according to claim 1, wherein said lifting device has at least two separate suction heads and said suction elements are component parts of said separate suction heads, said separate suction heads having suction faces for the printing plate which is to be attracted by suction and of which at least a first of said separate suction heads is mounted as a pivoting head, such that a first suction face can be moved at an angle to a second suction face of a second of said separate suction heads.

3. The apparatus according to claim 2, wherein said suction elements and/or said separate suction heads have vacuum devices which can be switched independently.

4. The apparatus according to claim 2, wherein said first suction face is moved by tilting.

5. The apparatus according to claim 2, wherein said pivoting head can be moved in a substantially horizontal direction while carrying with it the printing plate which is attracted by suction.

6. The apparatus according to claim 1, wherein the apparatus can be positioned on top of the unit for setting images on printing plates, as a component part of the loading device.
